(19) United States
(12) Patent Application Publication
(10) Pub. No.: US 2018/0285169 A1
(43) Pub. Date: Oct. 4, 2018

(54) INFORMATION PROCESSING SYSTEM AND COMPUTER-IMPLEMENTED METHOD

(71) Applicant: FUJITSU LIMITED, Kawasaki-shi (JP)

(72) Inventors: Shota Noguchi, Kawasaki (JP); KENICHIROU SHIMOGAWA, Numazu (JP)

(73) Assignee: FUJITSU LIMITED, Kawasaki-shi (JP)

(21) Appl. No.: 15/928,368

(22) Filed: Mar. 22, 2018

(30) Foreign Application Priority Data
Apr. 3, 2017 (JP) 2017-073717

(51) Int. Cl. G06F 9/50; G06F 11/30; G06F 11/34

(52) U.S. Cl. CPC G06F 9/5088; G06F 11/301; G06F 2209/5022; G06F 9/5077; G06F 11/3442

(57) ABSTRACT

An information processing system includes first, second, and third processors. The first processor assigns a processing request to one of virtual machines. The second processor determines whether there is a high load virtual machine whose load exceeds a predetermined threshold value among the virtual machines. The third processor determines whether to increase a number of the virtual machines based on a load of the respective virtual machines when the second processor determines that there is the high load virtual machine. The third processor determines whether to transfer processing to be performed by the high load virtual machine to a first virtual machine based on a number of processing requests assigned to the respective virtual machines upon determining that the number of virtual machines is not to be increased. The third processor makes the first virtual machine perform the processing upon determining that the processing is to be transferred.

### CROSS-REFERENCE TO RELATED APPLICATION

This application is based upon and claims the benefit of priority of the prior Japanese Patent Application No. 2017-073717, filed on Apr. 3, 2017, the entire contents of which are incorporated herein by reference.

### FIELD

The embodiment discussed herein is related to an information processing system, a computer-implemented method, and a non-transitory computer-readable recording medium having stored therein a program.

### BACKGROUND

Recently, with improvements in performance of information processing devices, a virtualization technology has been developed remarkably which operates a plurality of virtual machines on one physical machine. In the virtualization technology, for example, virtualization software allocates a physical machine to a plurality of virtual machines, and service is provided by each of the virtual machines. As a method of using the virtual machines, there is, for example, cloud service or the like in which an operator provides an infrastructure such as the virtual machines, a network, or the like to users via a network.

There is a technology that performs load distribution by assigning requests from clients to respective virtual machines in a case where the plurality of virtual machines are used as business servers in the cloud service or the like. A machine performing such load distribution may be referred to as a load balancer.

In addition, in a system that performs load distribution by a load balancer, there is a technology of automatically duplicating and adding a virtual machine as a distribution destination when a load on each virtual machine becomes high. This technology may be referred to as auto scaling. Auto scaling is performed by a management server managing the virtual machines based on a result of monitoring by a monitoring server monitoring the operations of the virtual machines.

Further, in the system that performs load distribution by the load balancer, there is a technology that, when a virtual machine as a business server goes down, starts a virtual machine on another physical machine, and transfers operation being performed by the virtual machine that has gone down to the newly started virtual machine. This technology may be referred to as auto failover. In auto failover, the management server detects that a virtual machine goes down and starts a virtual machine. The business server is restored by performing the auto failover.

Incidentally, as a technology for server load distribution, there is a conventional technology that analyzes requests input to servers in a given period, creates an operation plan for controlling server loads, and controls the server loads based on the operation plan when a given condition is satisfied. In addition, as a technology for dealing with a fault in cloud service, there is a conventional technology that determines a dealing method based on the contents of a contract for the service. Further, there is a conventional technology that determines whether a fault has occurred or not based on a state of increase in the number of requests.

Examples of related-art documents are Japanese Laid-open Patent Publication No. 2016-58005, Japanese Laid-open Patent Publication No. 2016-139237, and Japanese Laid-open Patent Publication No. 2015-95149.

### SUMMARY

According to an aspect of the present invention, provided is an information processing system including a first processor, a second processor, and a third processor. The first processor is configured to assign a processing request to one of virtual machines on a host device. The second processor is configured to determine whether there is a high load virtual machine whose load exceeds a predetermined threshold value among the virtual machines. The third processor is configured to determine whether to increase a number of virtual machines on the host device based on a load of the respective virtual machines when the second processor determines that there is the high load virtual machine. The third processor is configured to determine whether to transfer processing to be performed by the high load virtual machine to a first virtual machine on the host device based on a number of processing requests assigned to the respective virtual machines upon determining that the number of virtual machines is not to be increased. The third processor is configured to make the first virtual machine perform the processing to be performed by the high load virtual machine upon determining that the processing to be performed by the high load virtual machine is to be transferred.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a system configuration diagram of an information processing system;

FIG. 2 is a block diagram of an information processing system according to an embodiment;

FIG. 3 is a diagram illustrating an example of CPU usage rates in a case where auto scaling is performed;

FIG. 4 is a diagram illustrating an example of CPU usage rates in a case where there is a possibility that a fault has occurred;

FIG. 5 is a diagram illustrating a state of an information processing system in a case where auto scaling has been performed;

FIG. 6 is a diagram illustrating an example of the numbers of assigned requests in a case where failover is not performed;

FIG. 7 is a diagram illustrating an example of the numbers of assigned requests in a case where a failover is performed;

FIG. 8 is a diagram illustrating a state of an information processing system in a case where a failover is performed;

FIG. 9 is a diagram of assistance in explaining a state of a virtual machine in which a fault is determined to have occurred;

FIG. 10 is a flowchart of high load time processing performed by a management server according to the embodiment;

FIG. 11 is a flowchart of processing of auto scaling;

FIG. 12 is a flowchart of processing of failover; and

FIG. 13 is a diagram of a hardware configuration of an information processing device.

### DESCRIPTION OF EMBODIMENT

However, in the system that performs auto scaling based on the loads of the virtual machines, in a case where a fault occurs and a load is not decreased, the load of the virtual machine in which the fault has occurred is not decreased even when auto scaling is performed. In that case, unless the occurrence of the fault is detected, scaling out is repeated up to a maximum number of virtual machines that may be created.

In addition, in a configuration that monitors a central processing unit (CPU) usage rate and detects a failure, for example, a virtual machine that is under a temporarily high load depending on time may be failed over.

In addition, even when the conventional technology is used which performs load distribution based on the created operation plan, it is difficult to avoid performing unnecessary scaling out and a failover of a virtual machine under a temporarily high load. This is also true for the case of using the conventional technology of determining the dealing method based on the contents of the contract for the service. In addition, in the case of using the conventional technology of determining whether a fault has occurred or not based on a state of increase in the number of requests, it is possible to avoid performing unnecessary scaling out, but a failover of a virtual machine under a temporarily high load is performed, so that reliability may be decreased.

An embodiment of an information processing system, a computer-implemented method, and a non-transitory computer-readable recording medium having stored therein a program disclosed in the present application will hereinafter be described in detail with reference to the drawings. It is to be noted that the following embodiment does not limit the information processing system, the computer-implemented method, and the non-transitory computer-readable recording medium having stored therein a program disclosed in the present application.

### Embodiment

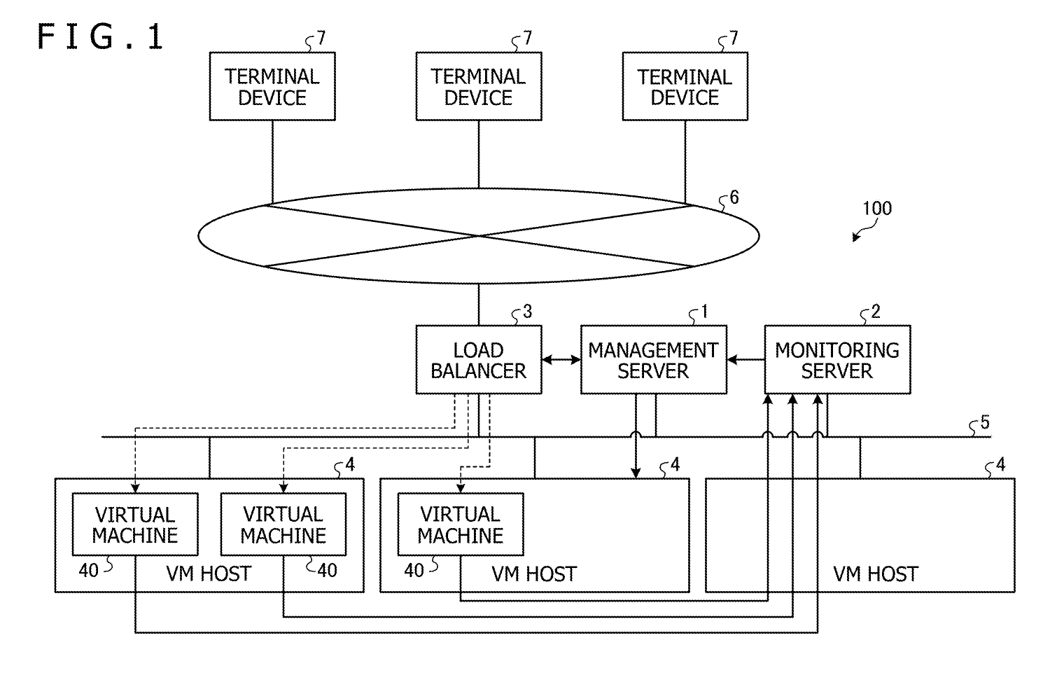

FIG. 1 is a system configuration diagram of an information processing system. As illustrated in FIG. 1, an information processing system 100 includes a management server 1, a monitoring server 2, a load balancer 3, virtual machine (VM) hosts 4, and terminal devices 7.

The management server 1, the monitoring server 2, the load balancer 3, and the VM hosts 4 are coupled to one another via a local area network (LAN) 5. In addition, the load balancer 3 and the terminal devices 7 are coupled to a network 6. The network 6 is, for example, the Internet.

The VM hosts 4 are, for example, a physical server. A VM host 4 may operate one or a plurality of virtual machines 40. Here, in FIG. 1, a maximum of two virtual machines 40 are included in one VM host 4. In actuality, however, any number of virtual machines 40 may be started on one VM host 4. In addition, the VM hosts 4 may operate virtual machines 40, or may not operate any virtual machine 40. A VM host 4 not including any virtual machine 40 in FIG. 1 is in a state of not operating any virtual machine 40. A VM host 4 generates and operates a virtual machine 40 upon receiving an instruction from the management server 1 to be described later. In addition, a VM host 4 deletes a virtual machine 40 operating on the own device upon receiving an instruction from the management server 1. This VM host 4 corresponds to an example of a “business processing device.”

Each virtual machine 40 is a business server providing one service. Each virtual machine 40 processes a request as a processing request transmitted from a terminal device 7. Each virtual machine 40 may perform same processing, and same processing is performed even when the request transmitted from the terminal device 7 is sent to any virtual machine 40 on any VM host 4. This virtual machine 40 corresponds to an example of a “processing performing unit” and a “processing performing device.”

The terminal devices 7 are an information processing terminal that receives service provided by a virtual machine 40. A terminal device 7 transmits a request to a virtual machine 40 via the network 6. Broken line arrows in FIG. 1 represent flows of requests. In FIG. 1, three terminal devices 7 are included. However, the number of terminal devices 7 is not particularly limited.

The load balancer 3 receives information about virtual machines 40 as assignment destinations of requests from the management server 1. The information about the virtual machines 40 may be the addresses of the virtual machines 40, or may be the names of the virtual machines 40 when there is a domain name system (DNS) server. The load balancer 3 receives a request output by a terminal device 7 via the network 6. Then, the load balancer 3 assigns the request to one of the virtual machines 40 as the assignment destinations, and transmits the request to the assigned virtual machine 40.

Request assignment by the load balancer 3 will be described in the following. The load balancer 3 stores request information about the numbers of requests transmitted to respective virtual machines 40 and the contents of the requests or the like. Then, when the load balancer 3 receives a new request, the load balancer 3 determines a virtual machine 40 to which to assign the received request such that the processing loads of the respective virtual machines 40 become uniform. For example, the load balancer 3 determines a virtual machine 40 to which to assign the received request such that the numbers of requests processed by the respective virtual machines 40 become uniform. However, the method of determining the virtual machine 40 to which to assign the request is not limited to this, and may be another method as long as the processing loads may be made uniform. For example, the load balancer 3 may obtain processing times from the contents of requests or the like, and determine the virtual machine 40 such that the times taken to complete processing become uniform.

In addition, the load balancer 3 transmits information about the virtual machine 40 to which the request is assigned to the management server 1. When auto scaling or failover is thereafter performed, the load balancer 3 receives input of information about an added or stopped virtual machine 40 from the management server 1. Then, the load balancer 3 adds the added virtual machine 40 to the request assignment destinations, excludes the stopped virtual machine 40 from the request assignment destinations, and performs request assignment. The load balancer 3 corresponds to an example of a “load distributing device.”

The monitoring server 2 obtains the CPU usage rates of the respective virtual machines 40. Then, the monitoring server 2 identifies a virtual machine 40 having a high load from the obtained CPU usage rates of the respective virtual machines 40, and notifies the virtual machine 40 having a high load to the management server 1.

The management server 1 receives, from the monitoring server 2, the notification of information about the CPU usage rates of the respective virtual machines 40 and the virtual machine 40 having a high load. In addition, the management server 1 receives, from the load balancer 3, information about the virtual machines 40 to which requests are transmitted. Next, the management server 1 counts the number of transmitted requests for each virtual machine 40, and calculates a rate of assignment of the requests to each virtual machine 40. Then, the management server 1 determines whether or not to perform auto scaling or failover using the CPU usage rates and the request assignment rates.

When auto scaling is performed, the management server 1 selects a VM host 4 on which to start a virtual machine 40, and instructs the selected VM host 4 to start the virtual machine 40. The management server 1 further transmits information about the started virtual machine 40 to the load balancer 3.

In addition, when failover is performed, the management server 1 identifies a virtual machine 40 in which a fault has occurred. Next, the management server 1 selects a VM host 4 on which to start a virtual machine 40, and instructs the selected VM host 4 to start the virtual machine 40. Next, the management server 1 transmits information about the started virtual machine 40 to the load balancer 3. Then, the management server 1 notifies the load balancer 3 of an instruction to transfer processing of the virtual machine 40 in which the fault has occurred to the started virtual machine 40. Thereafter, the management server 1 instructs a VM host 4 operating the virtual machine 40 in which the fault has occurred to stop the virtual machine 40 in which the fault has occurred. The monitoring server 2 and the management server 1 correspond to an example of a “management control device.”

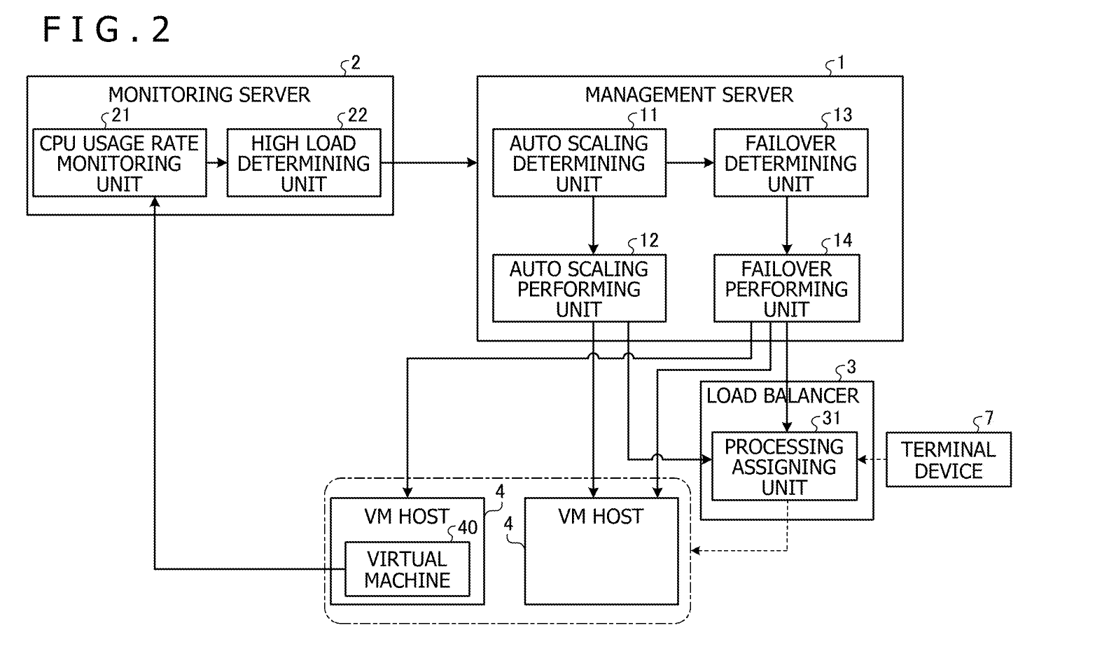

The execution of auto scaling or failover by the management server 1 will further be described in detail with reference to FIG. 2. FIG. 2 is a block diagram of an information processing system according to an embodiment. FIG. 2 includes functional units related to the execution of auto scaling or failover. In the following, auto scaling and failover will be referred to collectively as “high load time processing.”

The monitoring server 2 includes a CPU usage rate monitoring unit 21 and a high load determining unit 22. The CPU usage rate monitoring unit 21 monitors and obtains the CPU usage rates of the respective virtual machines 40 operated by the respective VM hosts 4. The CPU usage rate monitoring unit 21 then transmits the obtained CPU usage rates of the respective virtual machines 40 to the high load determining unit 22, which will be described later, of the monitoring server 2.

The high load determining unit 22 has, in advance, a high load threshold value for the CPU load rates to determine whether or not to perform high load time processing. For example, the high load determining unit 22 stores 80% as a high load threshold value.

The high load determining unit 22 receives the CPU usage rates of the respective virtual machines 40 from the CPU usage rate monitoring unit 21 of the monitoring server 2. Next, the high load determining unit 22 compares the CPU usage rates of the respective virtual machines 40 with the high load threshold value, and determines whether or not there is a virtual machine 40 whose CPU usage rate exceeds the high load threshold value. When there is no virtual machine 40 whose CPU usage rate exceeds the high load threshold value, the high load determining unit 22 ends the high load time processing, and waits until timing of determination for performing next high load time processing. The high load determining unit 22 performs this determination processing in given cycles.

When there is a virtual machine 40 whose CPU usage rate exceeds the high load threshold value, on the other hand, the high load determining unit 22 identifies the virtual machine 40 as a high load virtual machine. This high load virtual machine corresponds to an example of a “high load processing performing unit.” The high load determining unit 22 thereafter notifies information about the virtual machine 40 identified as the high load virtual machine to an auto scaling determining unit 11 of the management server 1. The high load determining unit 22 further notifies information about the CPU usage rates of the respective virtual machines 40 to the auto scaling determining unit 11

The management server 1 includes the auto scaling determining unit 11, an auto scaling performing unit 12, a failover determining unit 13, and a failover performing unit 14.

The auto scaling determining unit 11 has, in advance, a safety coefficient as a reference value for determining whether or not to perform auto scaling. The safety coefficient is a value indicating a deviation between an average value of the CPU usage rates of virtual machines 40 other than the high load virtual machine and the CPU usage rate of the high load virtual machine. The auto scaling determining unit 11, for example, stores 1.5 as the safety coefficient.

The auto scaling determining unit 11 obtains information about the virtual machine 40 identified as the high load virtual machine from the high load determining unit 22 of the monitoring server 2. The auto scaling determining unit 11 also obtains the CPU usage rates of the respective virtual machines 40 from the high load determining unit 22.

The auto scaling determining unit 11 calculates the average value of the CPU usage rates of the virtual machines 40 other than the high load virtual machine. Next, the auto scaling determining unit 11 divides the CPU usage rate of the high load virtual machine by the calculated average value of the CPU usage rates of the virtual machines 40 other than the high load virtual machine, and thereby calculates a ratio of the CPU usage rate of the high load virtual machine to the average value. The auto scaling determining unit 11 then determines whether or not the ratio of the CPU usage rate of the high load virtual machine to the average value is less than the safety coefficient.

When the ratio of the CPU usage rate of the high load virtual machine to the average value is less than the safety coefficient, the auto scaling determining unit 11 determines that an overall high load has occurred on the virtual machines 40. When an overall high load has occurred, there is a small possibility that a fault has occurred in the high load virtual machine, and there is a strong possibility of the high load being resolved by increasing the virtual machines 40. Accordingly, the auto scaling determining unit 11 instructs the auto scaling performing unit 12 to perform auto scaling.

When the ratio of the CPU usage rate of the high load virtual machine to the average value is equal to or more than the safety coefficient, on the other hand, the auto scaling determining unit 11 determines that there is a possibility that a fault has occurred in the virtual machine 40. Accordingly, the auto scaling determining unit 11 notifies the failover determining unit 13 of information about the virtual machine 40 as the high load virtual machine. This auto scaling determining unit 11 corresponds to an example of a “first determining unit.”

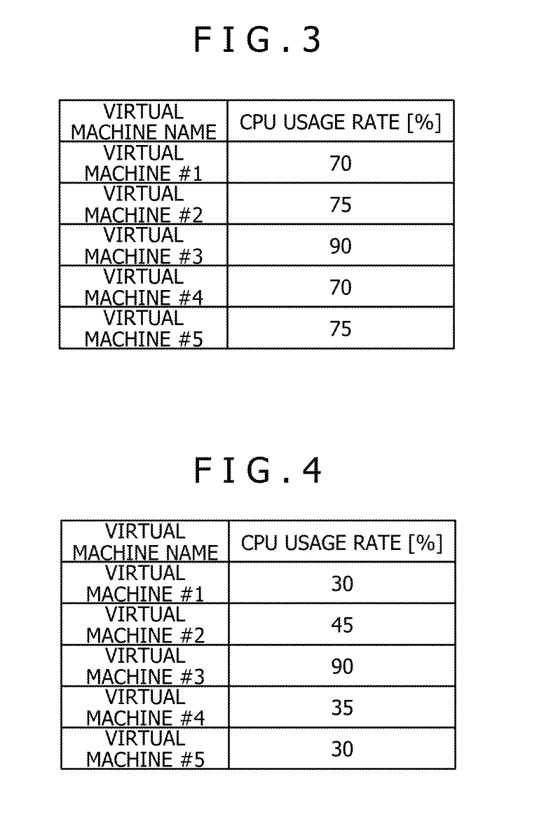

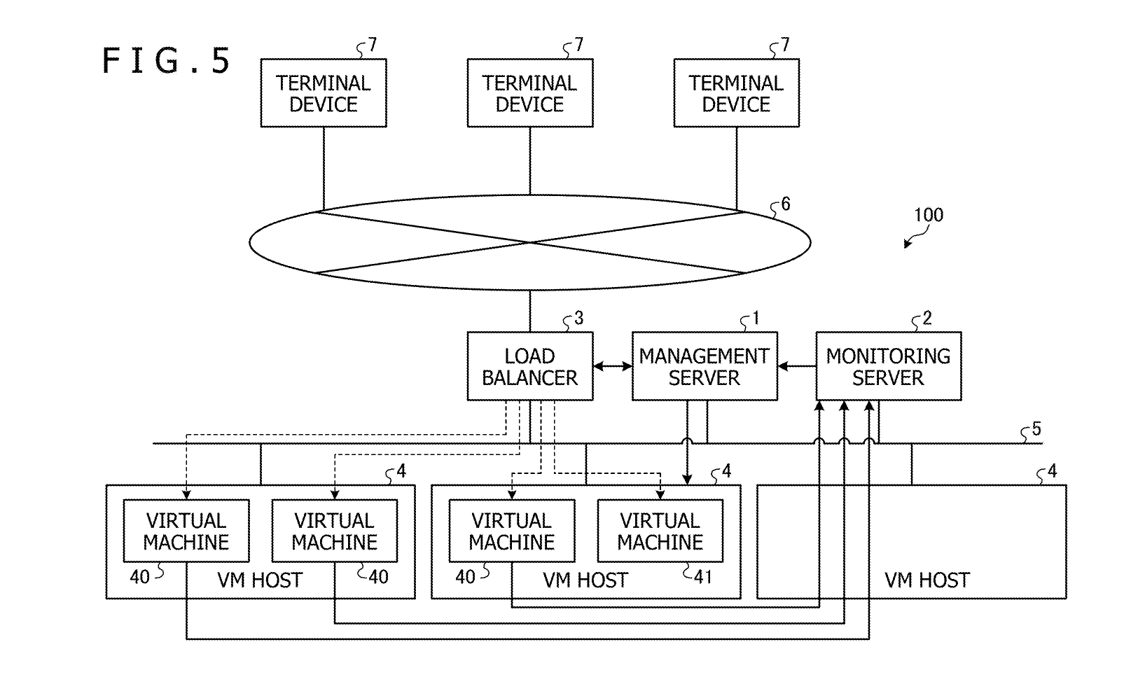

A concrete example of determination by the auto scaling determining unit 11 will be described in the following with reference to FIG. 3 and FIG. 4. FIG. 3 is a diagram illustrating an example of CPU usage rates in a case where auto scaling is performed. In addition, FIG. 4 is a diagram illustrating an example of CPU usage rates in a case where there is a possibility that a fault has occurred. The following description will be made of a case where five virtual machines having virtual machine names of virtual machines #1 to #5 are present as the virtual machines 40. In addition, description will be made of a case where the high load threshold value is 80% and the safety coefficient is 1.5.

In a case where the CPU usage rates of the respective virtual machines #1 to #5 are values illustrated in FIG. 3, the virtual machine #3 whose CPU usage rate is not less than 80% is identified as the high load virtual machine. Then, the auto scaling determining unit 11 calculates an average of the CPU usage rates of the virtual machines #1, #2, #4, and #5. In this case, the average of the CPU usage rates of the virtual machines #1, #2, #4, and #5 is 72.5%. Next, the auto scaling determining unit 11 calculates a ratio of the CPU usage rate of the virtual machine #3 to the average of the CPU usage rates of the virtual machines #1, #2, #4, and #5. In this case, the ratio of the CPU usage rate of the virtual machine #3 to the average of the CPU usage rates of the virtual machines #1, #2, #4, and #5 is approximately 1.24. Next, the auto scaling determining unit 11 compares the ratio of the CPU usage rate of the virtual machine #3 to the average of the CPU usage rates of the virtual machines #1, #2, #4, and #5 with the safety coefficient. In this case, the ratio of the CPU usage rate of the virtual machine #3 to the average of the CPU usage rates of the virtual machines #1, #2, #4, and #5 is less than the safety coefficient. The auto scaling determining unit 11 therefore determines that auto scaling is to be performed.

In a case where the CPU usage rates of the respective virtual machines #1 to #5 are values illustrated in FIG. 4, on the other hand, the virtual machine #3 whose CPU usage rate is not less than 80% is identified as the high load virtual machine. Then, the auto scaling determining unit 11 calculates an average of the CPU usage rates of the virtual machines #1, #2, #4, and #5. In this case, the average of the CPU usage rates of the virtual machines #1, #2, #4, and #5 is 35%. Next, the auto scaling determining unit 11 calculates the ratio of the CPU usage rate of the virtual machine #3 to the average of the CPU usage rates of the virtual machines #1, #2, #4, and #5. In this case, the ratio of the CPU usage rate of the virtual machine #3 to the average of the CPU usage rates of the virtual machines #1, #2, #4, and #5 is approximately 2.57. Next, the auto scaling determining unit 11 compares the ratio of the CPU usage rate of the virtual machine #3 to the average of the CPU usage rates of the virtual machines #1, #2, #4, and #5 with the safety coefficient. In this case, the ratio of the CPU usage rate of the virtual machine #3 to the average of the CPU usage rates of the virtual machines #1, #2, #4, and #5 is not less than the safety coefficient, and therefore the virtual machine #3 is under a higher load than the virtual machines #1, #2, #4, and #5. Accordingly, the auto scaling determining unit 11 determines that there is a possibility that a fault has occurred in the virtual machine #3.

Description will be continued with reference to FIG. 2 again. The auto scaling performing unit 12 receives an instruction to perform auto scaling from the auto scaling determining unit 11. The auto scaling performing unit 12 then selects a VM host 4 that may start a virtual machine 40. The auto scaling performing unit 12 thereafter instructs the selected VM host 4 to start the virtual machine 40. Thereafter, the auto scaling performing unit 12 notifies information about the newly started virtual machine 40 to a processing assigning unit 31 of the load balancer 3, and completes the auto scaling processing.

FIG. 5 is a diagram illustrating a state of an information processing system in a case where auto scaling has been performed. FIG. 5 illustrates a state in which auto scaling has been performed in the information processing system 100 in the state of FIG. 1. In FIG. 5, a newly started virtual machine 40 is represented as a virtual machine 41. In addition, in FIG. 5, the management server 1 selects the second VM host 4 from the left in the figure as the VM host 4 on which to start the new virtual machine 41. The management server 1 then transmits an instruction to start the new virtual machine 41 to the selected VM host 4. Then, receiving the start instruction, the VM host 4 starts the new virtual machine 41. The management server 1 thereafter notifies the load balancer 3 of information about the virtual machine 41. Thus, the load balancer 3 adds the virtual machine 41 to the existing virtual machines 40, and performs request assignment.

Description will be continued with reference to FIG. 2 again. The failover determining unit 13 receives, from the processing assigning unit 31 of the load balancer 3, information about the virtual machines 40 to which respective requests are transmitted. The failover determining unit 13 then stores the obtained request information in correspondence with the virtual machines 40 as transmission destinations.

When the auto scaling determining unit 11 determines that there is a possibility that a fault has occurred in a virtual machine 40, the failover determining unit 13 receives a notification of information about the virtual machine 40 as the high load virtual machine from the auto scaling determining unit 11. Here, the failover determining unit 13 waits for a certain time. This is to avoid occurrence of a failover due to an instantaneous rise in the CPU usage rate. It suffices for the certain time for which the failover determining unit 13 waits to be a time in which there is a possibility of resolving the instantaneous rise in the CPU usage rate depending on an operation environment. The certain time for which the failover determining unit 13 waits is, for example, approximately one minute.

Thereafter, the failover determining unit 13 obtains the number of requests transmitted during a period preceding by a given time from that timing for each virtual machine 40. Then, the failover determining unit 13 divides the number of requests to the high load virtual machine by a total number of requests to the virtual machines 40 to which load distribution is performed in conjunction with the high load virtual machine, and thereby calculates a request assignment rate of the high load virtual machine.

In addition, the failover determining unit 13 calculates a predicted request assignment rate, which is the request assignment rate of the high load virtual machine in a case where requests are evenly assigned to each virtual machine 40. For example, the failover determining unit 13 calculates, as the predicted request assignment rate, a value obtained by dividing 100 by the number of all of the virtual machines 40 to which load distribution is performed in conjunction with the high load virtual machine.

Here, the failover determining unit 13 has a failover threshold value in advance, the failover threshold value being a threshold value of a ratio between the request assignment rate and the predicted request assignment rate to determine whether or not to perform a failover. This failover threshold value corresponds to an example of a “given value.”

When a temporarily high load occurs on the high load virtual machine, the request assignment rates of the respective virtual machines 40 as targets of load balancing are similar values as viewed in a certain period. On the other hand, when the high load virtual machine has a continuously high load due to occurrence of a fault or the like separately from an overall tendency of the targets of load balancing, assignment of requests to the high load virtual machine is suppressed, and therefore the request assignment rate of the high load virtual machine is low.

Accordingly, the failover determining unit 13 calculates the predicted request assignment rate as the request assignment rate of the high load virtual machine in a case where requests are evenly assigned to each virtual machine 40. For example, the failover determining unit 13 calculates, as the predicted request assignment rate, a value obtained by dividing 100 by the number of all of the virtual machines 40 set to be targets of load balancing as business servers.

Then, the failover determining unit 13 divides the predicted request assignment rate by the actual request assignment rate of the high load virtual machine, and thereby calculates an assignment rate ratio. The failover determining unit 13 next determines whether or not the calculated assignment rate ratio is less than the failover threshold value. When the assignment rate ratio is equal to or more than the request failover threshold value, the failover determining unit 13 determines that a temporarily high load has occurred on the virtual machine 40 as the high load virtual machine, and that no fault has occurred yet. The failover determining unit 13 then ends the failover processing.

On the other hand, when the assignment rate ratio is less than the request failover threshold value, the failover determining unit 13 determines that a fault has occurred in the virtual machine 40 as the high load virtual machine, and instructs the failover performing unit 14 to perform a failover. The virtual machine 40 in which a fault is considered to have occurred in the following corresponds to the virtual machine 40 as the high load virtual machine. This failover determining unit 13 corresponds to an example of a “second determining unit.”

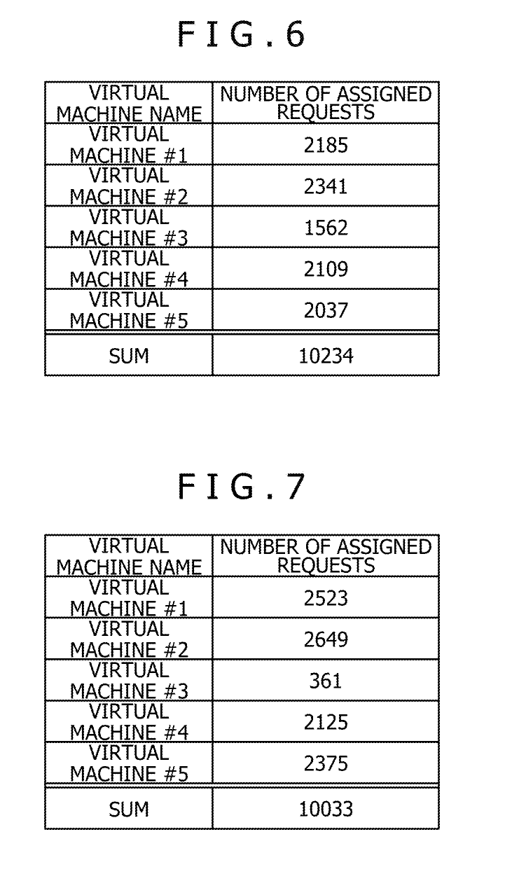

A concrete example of determination by the failover determining unit 13 will be described in the following with reference to FIG. 6 and FIG. 7. FIG. 6 is a diagram illustrating an example of the numbers of assigned requests in a case where failover is not performed. In addition, FIG. 7 is a diagram illustrating an example of the numbers of assigned requests in a case where failover is performed. Also in the following, description will be made of a case where five virtual machines having virtual machine names of virtual machines #1 to #5 are present as the virtual machines 40. In addition, description will be made of a case where the failover threshold value is two. In addition, suppose that the virtual machine #3 is the high load virtual machine.

When the numbers of assigned requests representing the numbers of requests transmitted to the respective virtual machines #1 to #5 are values illustrated in FIG. 6, the failover determining unit 13 calculates a predicted number of assigned requests as 1/5×100=20. Next, the failover determining unit 13 calculates an actual number of assigned requests of the virtual machine #3 by dividing the number of assigned requests of the virtual machine #3 by a sum of the numbers of assigned requests. In this case, the actual number of assigned requests of the virtual machine #3 is approximately 15.26. The failover determining unit 13 next calculates an assignment rate ratio by dividing the predicted number of assigned requests by the actual number of assigned requests of the virtual machine #3. In this case, the assignment rate ratio is 1.31. The failover determining unit 13 then compares the calculated assignment rate ratio with the failover threshold value. In this case, the assignment rate ratio is less than the failover threshold value. The failover determining unit 13 therefore determines that the virtual machine #3 is temporarily under a high load, and determines that failover is not to be performed.

Also when the numbers of assigned requests representing the numbers of requests transmitted to the respective virtual machines #1 to #5 are values illustrated in FIG. 7, on the other hand, the failover determining unit 13 calculates a predicted number of assigned requests as 1/5×100=20. The failover determining unit 13 next calculates an actual number of assigned requests of the virtual machine #3 by dividing the number of assigned requests of the virtual machine #3 by a sum of the numbers of assigned requests. In this case, the actual number of assigned requests of the virtual machine #3 is approximately 3.60. The failover determining unit 13 next calculates an assignment rate ratio by dividing the predicted number of assigned requests by the actual number of assigned requests of the virtual machine #3. In this case, the assignment rate ratio is 5.56. The failover determining unit 13 then compares the calculated assignment rate ratio with the failover threshold value. In this case, the assignment rate ratio is not less than the failover threshold value. The failover determining unit 13 determines that there is a possibility that a fault has occurred in the virtual machine #3, and determines that a failover is to be performed.

Description will be continued with reference to FIG. 2 again. The failover performing unit 14 receives an instruction to perform a failover from the failover determining unit 13. The failover performing unit 14 then selects one VM host 4 other than the VM host 4 operating the virtual machine 40 in which a fault is considered to have occurred. The failover performing unit 14 then instructs the selected VM host 4 to start a virtual machine 40.

Next, the failover performing unit 14 notifies information about the virtual machine 40 in which a fault is considered to have occurred to the processing assigning unit 31 of the load balancer 3. Further, the failover performing unit 14 notifies information about the newly started virtual machine 40 to the processing assigning unit 31. Next, the failover performing unit 14 notifies the processing assigning unit 31 of an instruction to transfer processing of a request transmitted to the virtual machine 40 in which a fault is considered to have occurred to the newly started virtual machine 40. This failover performing unit 14 corresponds to an example of a “changing unit.”

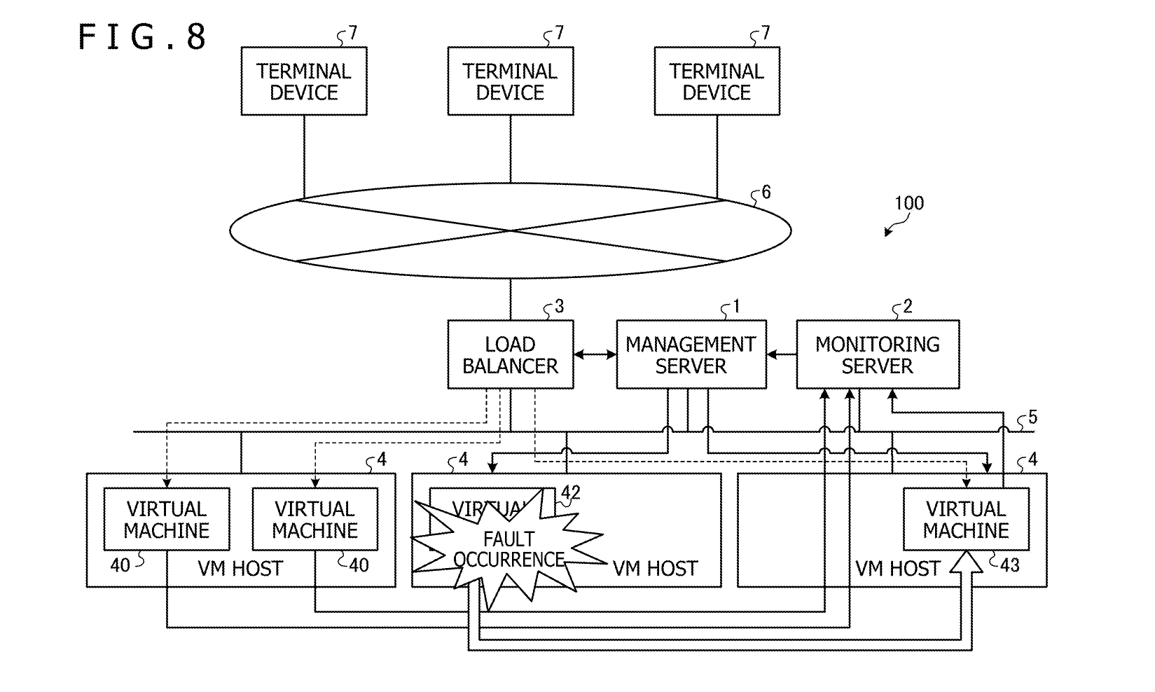

FIG. 8 is a diagram illustrating a state of an information processing system in a case where a failover is performed. FIG. 8 represents a state in a case where a failover is performed in the information processing system 100 in the state of FIG. 1. In FIG. 8, the virtual machine 40 in which a fault is considered to have occurred is represented as a virtual machine 42. In addition, a virtual machine 40 as a transfer destination of processing to be performed by the virtual machine 42 is represented as a virtual machine 43. The management server 1 determines that a fault has occurred in the virtual machine 42 by using the request assignment rate. The management server 1 then selects a VM host 4 other than the VM host 4 operating the virtual machine 42. The management server 1 next transmits an instruction to start the new virtual machine 43 to the selected VM host 4. Then, receiving the start instruction, the VM host 4 starts the new virtual machine 43. The management server 1 thereafter notifies information about the virtual machine 43 to the load balancer 3. The management server 1 further instructs the load balancer 3 to transfer the processing to be performed by the virtual machine 42 to the virtual machine 43. The processing to be performed by the virtual machine 42 is thereby transferred to the virtual machine 43. Further, the load balancer 3 adds the virtual machine 43 to the existing virtual machines 40, and performs request assignment. Thereafter, the management server 1 instructs the VM host 4 operating the virtual machine 42 to stop the virtual machine 42 in which a failure is considered to have occurred. Receiving the instruction, the VM host 4 stops the virtual machine 42, and deletes the virtual machine 42. Thereafter, the management server 1 notifies information about the virtual machine 42 in which a fault is considered to have occurred to the load balancer 3. Thus, as illustrated in FIG. 8, switching from the virtual machine 42 in which a fault is considered to have occurred to the newly started virtual machine 43 is completed.

Description will be continued with reference to FIG. 2 again. In the present embodiment, when a fault occurs, in order to make the information processing system 100 maintain the states of business servers before the occurrence of the failure, a new virtual machine 40 is started, and processing to be performed by a virtual machine 40 in which a fault has occurred is transferred to the newly started virtual machine 40. However, when a decrease in the number of virtual machines 40 as targets of load balancing may be tolerated, the management server 1 may transfer the processing to be performed by the virtual machine 40 in which the failure has occurred to an existing virtual machine 40 other than the virtual machine 40 in which the failure has occurred.

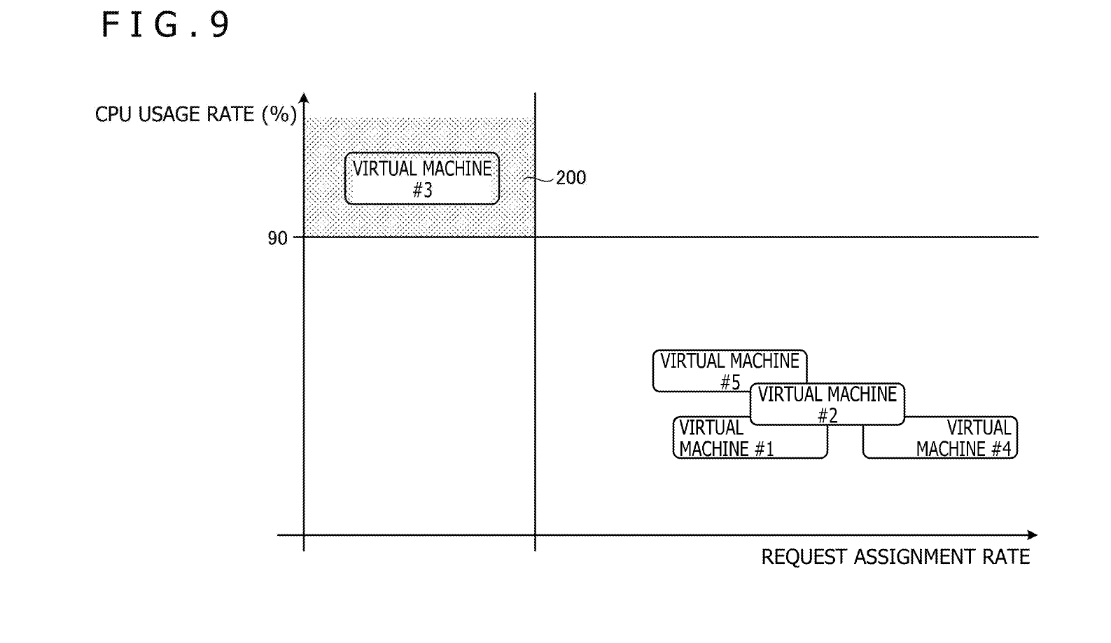

FIG. 9 is a diagram of assistance in explaining a state of a virtual machine in which a fault is determined to have occurred. FIG. 9 represents a case where the virtual machines #1 to #5 are present, and the virtual machine 40 in which there is a possibility that a fault has occurred is the virtual machine #3.

The virtual machine #3 in which there is a possibility that a fault has occurred is a virtual machine 40 having a high CPU usage rate and having a higher CPU usage rate than the other virtual machines #1, #2, #4, and #5. Moreover, the virtual machine #3 in which there is a possibility that a fault has occurred is a virtual machine 40 having a low request assignment rate. For example, the management server 1 determines that there is a possibility that a fault has occurred in the virtual machine 40 when the state of the virtual machine 40 is included in a region 200.

The load balancer 3 includes the processing assigning unit 31. The processing assigning unit 31 assigns requests transmitted from the terminal devices 7 to respective virtual machines 40 operating on the respective VM hosts 4 such that loads become uniform, and transmits the assigned requests to the respective virtual machines 40. Virtual machines 40 operating on VM hosts 4 included in frames enclosed by alternate long and short dashed lines in FIG. 2 are virtual machines 40 as targets of load balancing. For example, the processing assigning unit 31 transmits requests to the virtual machines 40 within the frame of the alternate long and short dashed lines such that loads become uniform. Dotted line arrows in FIG. 3 represent a flow of the requests. Further, the processing assigning unit 31 notifies the assignment destinations of the requests received from the terminal devices 7 to the failover determining unit 13.

In addition, when auto scaling is performed, the processing assigning unit 31 receives information about a newly started virtual machine 40 from the auto scaling performing unit 12 of the management server 1. Then, the processing assigning unit 31 adds the newly started virtual machine 40 to the existing virtual machines 40, and performs load balancing. This increases the virtual machines 40 processing requests, and may therefore reduce loads on the respective virtual machines 40.

In addition, when a failover is performed, the processing assigning unit 31 receives information about a newly started virtual machine 40 from the failover performing unit 14 of the management server 1. The processing assigning unit 31 also receives information about a virtual machine 40 in which a fault is considered to have occurred from the failover performing unit 14. The processing assigning unit 31 further receives, from the failover performing unit 14, an instruction to transfer processing to be performed by the virtual machine 40 in which a failure is considered to have occurred to the newly started virtual machine 40.

Then, the processing assigning unit 31 retransmits requests whose processing is not yet completed among requests transmitted to the virtual machine 40 in which a fault is considered to have occurred to the newly started virtual machine 40. Thereafter, the processing assigning unit 31 excludes the virtual machine 40 in which a fault is considered to have occurred from the virtual machines 40 as targets of load balancing, further adds the newly started virtual machine 40, and performs load balancing. Thus, the processing to be performed by the virtual machine 40 in which a fault is considered to have occurred as the virtual machine 40 processing the requests is transferred to the newly started virtual machine 40, so that the processing of the requests may be continued.

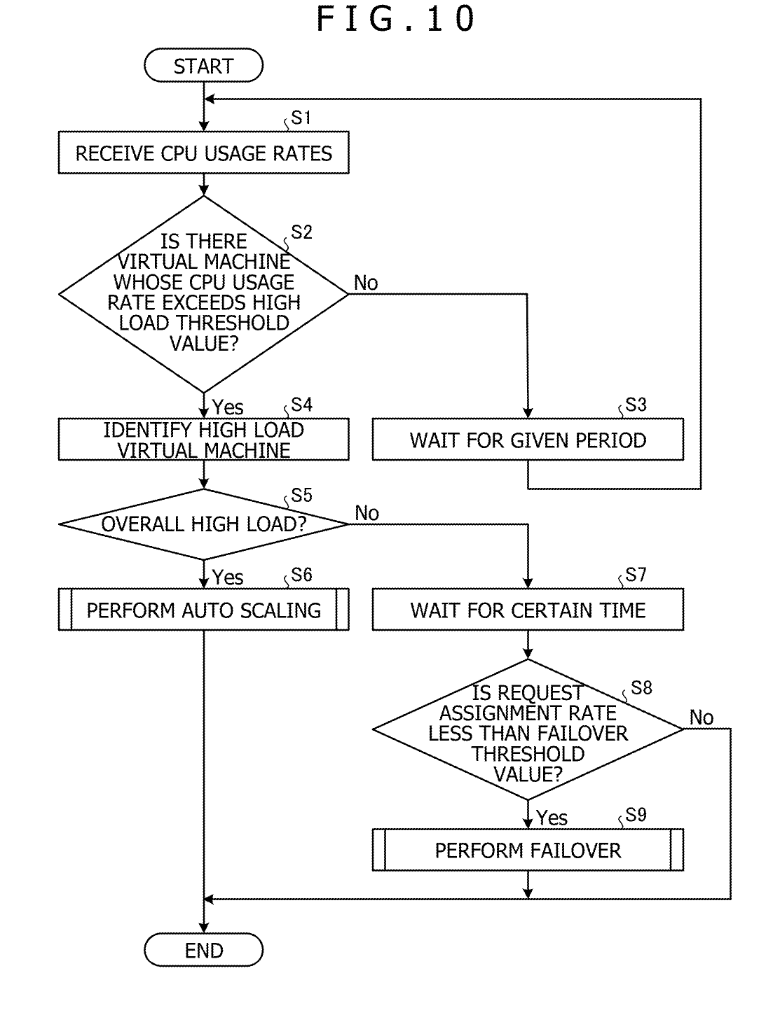

Next, a flow of high load time processing performed by the management server 1 according to the present embodiment will be described with reference to FIG. 10. FIG. 10 is a flowchart of high load time processing performed by a management server according to the embodiment.

The CPU usage rate monitoring unit 21 of the monitoring server 2 obtains the CPU usage rates of the respective virtual machines 40 operating on the respective VM hosts 4. Then, the high load determining unit 22 receives the CPU usage rates of the respective virtual machines 40 from the CPU usage rate monitoring unit 21 (step S1).

The high load determining unit 22 determines whether or not there is a virtual machine 40 whose CPU usage rate exceeds the high load threshold value (step S2). When there is no virtual machine 40 whose CPU usage rate exceeds the high load threshold value (step S2: negative), the high load determining unit 22 waits for a given period (step S3), and returns to step S1.

When there is a virtual machine 40 whose CPU usage rate exceeds the high load threshold value (step S2: affirmative), on the other hand, the high load determining unit 22 identifies the virtual machine 40 whose CPU usage rate exceeds the high load threshold value as a high load virtual machine (step S4). The high load determining unit 22 then outputs information about the virtual machine 40 as the high load virtual machine and the CPU usage rates of the respective virtual machines 40 to the auto scaling determining unit 11 of the management server 1.

The auto scaling determining unit 11 receives the input of the information about the virtual machine 40 as the high load virtual machine and the CPU usage rates of the respective virtual machines 40 from the high load determining unit 22. The auto scaling determining unit 11 then calculates a ratio of the CPU usage rate of the virtual machine 40 as the high load virtual machine to an average value of the CPU usage rates of the virtual machines 40 other than the high load virtual machine. Then, based on whether or not the calculated ratio is less than the safety coefficient, the auto scaling determining unit 11 determines whether or not an overall high load has occurred on the virtual machines 40 as targets of load balancing (step S5).

When the calculated ratio is less than the safety coefficient, and the auto scaling determining unit 11 determines that an overall high load has occurred (step S5: affirmative), the auto scaling determining unit 11 instructs the auto scaling performing unit 12 to perform auto scaling. Receiving the instruction to perform auto scaling, the auto scaling performing unit 12 performs auto scaling (step S6).

On the other hand, when the calculated ratio is equal to or more than the safety coefficient, and the auto scaling determining unit 11 determines that no overall high load has occurred (step S5: negative), the auto scaling determining unit 11 outputs information about the virtual machine 40 as the high load virtual machine to the failover determining unit 13. The failover determining unit 13 receives the input of the information about the virtual machine 40 as the high load virtual machine from the auto scaling determining unit 11. The auto scaling determining unit 11 then waits for a certain time (step S7).

Thereafter, the auto scaling determining unit 11 calculates the request assignment rate of the virtual machine 40 as the high load virtual machine using information about requests to the respective virtual machines 40, the information being obtained from the processing assigning unit 31 of the load balancer 3. The auto scaling determining unit 11 then determines whether or not the request assignment rate of the virtual machine 40 as the high load virtual machine is less than the failover threshold value (step S8). When the request assignment rate of the virtual machine 40 as the high load virtual machine is equal to or more than the failover threshold value (step S8: negative), the auto scaling determining unit 11 completes the failover processing.

When the request assignment rate of the virtual machine 40 as the high load virtual machine is less than the failover threshold value (step S8: affirmative), on the other hand, the auto scaling determining unit 11 performs a failover (step S9).

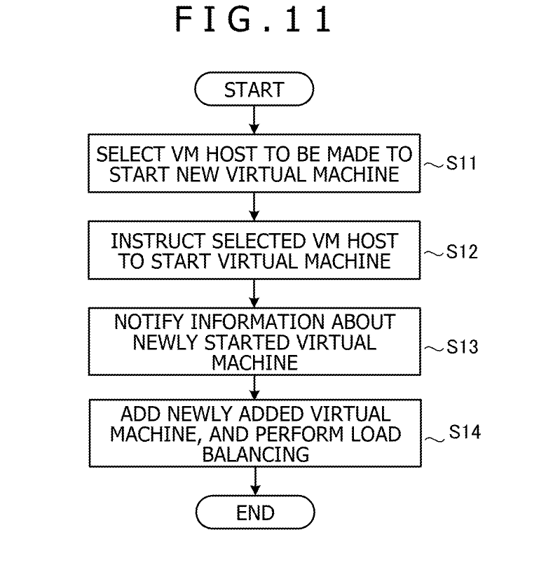

A flow of processing of auto scaling will next be described with reference to FIG. 11. FIG. 11 is a flowchart of processing of auto scaling. FIG. 11 corresponds to an example of the processing performed in step S6 in FIG. 10.

The auto scaling performing unit 12 selects a VM host 4 on which to start a new virtual machine 40 based on the load rates of the respective VM hosts 4 or the like (step S11).

Next, the auto scaling performing unit 12 instructs the selected VM host 4 to start the virtual machine 40 (step S12). Receiving the instruction, the VM host 4 starts the new virtual machine 40.

Next, the auto scaling performing unit 12 notifies information about the newly started virtual machine 40 to the processing assigning unit 31 (step S13). For example, in a case where there is a DNS, the auto scaling performing unit 12 notifies the name of the newly started virtual machine 40.

The processing assigning unit 31 receives the information about the newly started virtual machine 40 from the auto scaling performing unit 12. Then, the processing assigning unit 31 adds the newly started virtual machine 40 to the existing virtual machines 40, and performs load balancing (step S14).

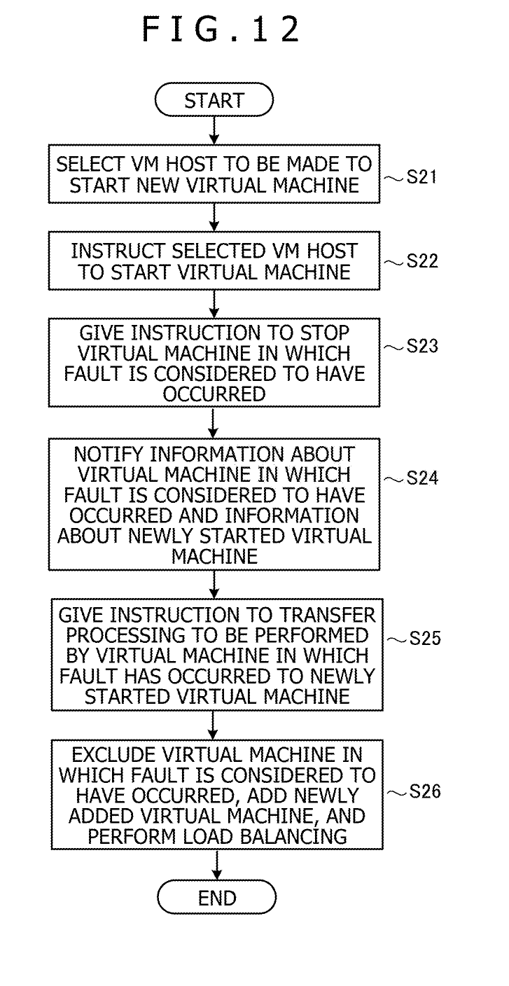

A flow of processing of failover will next be described with reference to FIG. 12. FIG. 12 is a flowchart of processing of failover. FIG. 12 corresponds to an example of the processing performed in step S9 in FIG. 10.

The failover performing unit 14 selects a VM host 4 on which to start a new virtual machine 40 based on the load rates of the respective VM hosts 4 or the like (step S21).

Next, the failover performing unit 14 instructs the selected VM host 4 to start the virtual machine 40 (step S22). Receiving the instruction, the VM host 4 starts the new virtual machine 40.

Next, the failover performing unit 14 instructs a VM host 4 operating a virtual machine 40 in which a fault is considered to have occurred to stop the virtual machine 40 in which a fault is considered to have occurred (step S23). Receiving the instruction, the VM host 4 stops the virtual machine 40 in which a fault is considered to have occurred.

Next, the failover performing unit 14 notifies the processing assigning unit 31 of information about the virtual machine 40 in which a failure is considered to have occurred and information about the newly started virtual machine 40 (step S24).

Further, the failover performing unit 14 instructs the processing assigning unit 31 to transfer processing to be performed by the virtual machine 40 in which a failure is considered to have occurred to the newly started virtual machine 40 (step S25).

The processing assigning unit 31 receives, from the failover performing unit 14, the information about the virtual machine 40 in which a failure is considered to have occurred and the information about the newly started virtual machine 40. The processing assigning unit 31 further receives, from the failover performing unit 14, the instruction to transfer the processing to be performed by the virtual machine 40 in which a failure has occurred to the newly started virtual machine 40. The processing assigning unit 31 then retransmits requests whose processing is not completed yet among requests transmitted to the virtual machine 40 in which a fault is considered to have occurred to the newly started virtual machine 40. The processing assigning unit 31 thereafter excludes the virtual machine 40 in which a fault has occurred from the virtual machines 40 as targets of load balancing, further adds the newly started virtual machine 40, and performs load balancing (step S26).

As described above, the management server according to the present embodiment determines whether to perform auto scaling using the CPU usage rates, and further determines whether to perform failover using the request assignment rate. It is thereby possible to avoid performing auto scaling at a time of occurrence of a fault, and avoid performing a failover due to a temporarily high load. Hence, it is possible to improve accuracy of determination as to whether to perform auto scaling and whether to perform failover, and consequently improve reliability of the system.

(Hardware Configuration)

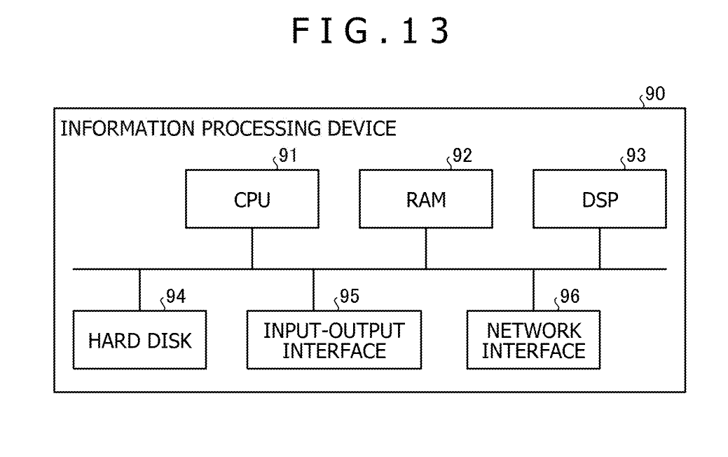

Hardware configurations of the management server 1, the monitoring server 2, and the load balancer 3 will next be described with reference to FIG. 13. FIG. 13 is a diagram of a hardware configuration of an information processing device. The management server 1, the monitoring server 2, and the load balancer 3 are, for example, implemented by an information processing device 90 illustrated in FIG. 13.

The information processing device 90 includes a CPU 91, a random access memory (RAM) 92, a digital signal processor (DSP) 93, a hard disk 94, an input-output interface 95, and a network interface 96. The CPU 91 is coupled to the RAM 92, the DSP 93, the hard disk 94, the input-output interface 95, and the network interface 96 by a bus.

The input-output interface 95 is coupled to input devices such as a keyboard, a mouse, and the like and output devices such as a monitor and the like. An operator performs input to the information processing device 90 using an input device. In addition, the operator checks information using an output device. In addition, the DSP 93 performs image display control. The DSP 93 displays an image on the monitor or the like via the input-output interface 95.

The network interface 96 is an interface for coupling to the LAN 5 and the network 6. The management server 1, the monitoring server 2, and the load balancer 3 are each coupled to the LAN 5 by the network interface 96, and communicate with the other apparatuses coupled to the LAN 5. In addition, the load balancer 3 is coupled to the network 6 by the network interface 96, and communicates with the terminal devices 7.

The hard disk 94 is an auxiliary storage device. The hard disk 94 in the management server 1 stores various programs including a program for implementing functions of the auto scaling determining unit 11, the auto scaling performing unit 12, the failover determining unit 13, and the failover performing unit 14 illustrated in FIG. 2. In addition, the hard disk 94 in the monitoring server 2 stores various programs including a program for implementing functions of the CPU usage rate monitoring unit 21 and the high load determining unit 22 illustrated in FIG. 2. In addition, the hard disk 94 in the load balancer 3 stores various programs including a program for implementing functions of the processing assigning unit 31 illustrated in FIG. 2.

The CPU 91 in the management server 1 reads the various programs from the hard disk 94, expands the programs onto the RAM 92 as a main storage device, and executes the programs. The CPU 91 in the management server 1 thereby implements functions of the auto scaling determining unit 11, the auto scaling performing unit 12, the failover determining unit 13, and the failover performing unit 14 illustrated in FIG. 2. In addition, the CPU 91 in the monitoring server 2 reads the various programs from the hard disk 94, expands the programs onto the RAM 92 as a main storage device, and executes the programs. The CPU 91 in the monitoring server 2 thereby implements functions of the CPU usage rate monitoring unit 21 and the high load determining unit 22 illustrated in FIG. 2. In addition, the CPU 91 in the load balancer 3 reads the various programs from the hard disk 94, expands the programs onto the RAM 92 as a main storage device, and executes the programs. The CPU 91 in the load balancer 3 thereby implements functions of the processing assigning unit 31 illustrated in FIG. 2. All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system, comprising:
a first processor configured to
assign a processing request to one of virtual machines on a host device;
a second processor configured to
determine whether there is a high load virtual machine, the high load virtual machine having a load that exceeds a predetermined threshold value among the virtual machines; and
a third processor configured to:
determine whether to increase a number of virtual machines on the host device based on a load of the respective virtual machines when the second processor determines that there is the high load virtual machine;
determine whether to transfer processing to be performed by the high load virtual machine to a first virtual machine on the host device based on a number of processing requests assigned to the respective virtual machines upon determining that the number of virtual machines is not to be increased; and
make the first virtual machine perform the processing to be performed by the high load virtual machine upon determining that the processing to be performed by the high load virtual machine is to be transferred.

2. The information processing system according to claim 1, wherein
the third processor is configured to
determine whether to increase the number of virtual machines by comparing an average of the load of the respective virtual machines excluding the high load virtual machine with the load of the high load virtual machine.

3. The information processing system according to claim 1, wherein
the third processor is configured to:
calculate an assignment rate of the high load virtual machine from the number of the processing requests assigned to the respective virtual machines by the first processor; and
determine whether to transfer the processing to be performed by the high load virtual machine to the first virtual machine based on the calculated assignment rate.

4. The information processing system according to claim 3, wherein
the third processor is configured to
determine that the processing to be performed by the high load virtual machine is to be transferred to the first virtual machine when the assignment rate of the high load virtual machine is lower than a predetermined value.

5. The information processing system according to claim 1, wherein
the third processor is configured to
determine whether to transfer the processing to be performed by the high load virtual machine to the first virtual machine after waiting for a predetermined time since the third processor determines that the number of virtual machines is not to be increased.

6. The information processing system according to claim 1, wherein
the third processor is configured to:
generate the first virtual machine;
make the generated virtual machine perform the processing to be performed by the high load virtual machine; and
stop the high load virtual machine.

7. The information processing system according to claim 1, wherein the load is a Computer Processing Unit (CPU) usage rate.

8. The information processing system according to claim 7, wherein
the third processor is configured to
calculate an average of the CPU usage rate of respective virtual machines excluding the high load virtual machine;
calculate a ratio of the high load virtual machine by dividing the CPU usage rate of the high load virtual machine with the calculated average;
compare the calculated ratio with a predetermined value; and
determine to increase the number of virtual machines when the calculated ratio if less than predetermined value.

9. A non-transitory computer-readable recording medium having stored therein a program that causes a computer to execute a process, the process comprising:
assigning a processing request to one of virtual machines on a host device;
determining whether there is a high load virtual machine, the high load virtual machine having a load that load exceeds a predetermined threshold value among the virtual machines;
determining whether to increase a number of virtual machines on the host device based on a load of the respective virtual machines when it is determined that there is the high load virtual machine;
determining whether to transfer processing to be performed by the high load virtual machine to a first virtual machine on the host device based on a number of processing requests assigned to the respective virtual machines when it is determined that the number of virtual machines is not to be increased; and
making the first virtual machine perform the processing to be performed by the high load virtual machine when it is determined that the processing to be performed by the high load virtual machine is to be transferred.

10. A computer-implemented method, comprising:
obtaining, by a computer, Central Processing Unit (CPU) usage rates from a plurality of virtual machines operating on at least one host device;
identifying a virtual machine of the virtual machines as a high load virtual machine when a CPU usage rate of a virtual machine is above a high load threshold value;
calculating a request assignment rate for each of the plurality of virtual machines;
determining whether to perform high load time processing based on the obtained usage rates and the calculated request assignment rates; and
performing the high load time processing based on the determining.

11. The method according to claim 10, wherein
the high load time processing includes at least one of auto-scaling and failover processing.

12. The method according to claim 11, wherein the determining includes:
calculating an average of the CPU usage rate of respective virtual machines excluding the high load virtual machine;
calculating a ratio of the high load virtual machine by dividing the CPU usage rate of the high load virtual machine with the calculated average;
comparing the calculated ratio with a predetermined value; and
determining to perform the auto scaling to increase the number of virtual machines when the calculated ratio is less than predetermined value.

13. The method according to claim 12, further comprising:
waiting an amount of time before performing the high load time processing when the comparing indicates the calculated ratio is greater than the predetermined value.

14. The method according to claim 13, further comprising:
calculating a request assignment rate of the high load virtual machine by dividing requests for the high load virtual machine by a total number of request for the plurality of virtual machines during a given time period;
comparing the calculated request assignment rate of the high load virtual machine with a failover threshold value; and
performing the failover processing when the request assignment rate of the high load virtual machine is less than failover threshold value.
